(19) United States
(12) Patent Application Publication
(10) Pub. No.: US 2026/0367046 A1
(43) Pub. Date: Nov. 19, 2026

(54) METHOD FOR DETERMINING SHORT-CHAIN FATTY ACID CONTENT IN INTESTINAL CONTENTS OR FECES

(71) Applicants: INSTITUTE OF APICULTURAL RESEARCH, CHINESE ACADEMY OF AGRICULTURAL SCIENCES, Beijing (CN); INSTITUTE OF SUBTROPICAL AGRICULTURE, CHINESE ACADEMY OF SCIENCES, Changsha (CN)

(72) Inventors: Kai WANG, Beijing (CN); Xing ZHENG, Beijing (CN); Xia XIONG, Changsha (CN); Liming WU, Beijing (CN); Wenjun PENG, Beijing (CN)

(73) Assignees: INSTITUTE OF APICULTURAL RESEARCH, CHINESE ACADEMY OF AGRICULTURAL SCIENCES, Beijing (CN); INSTITUTE OF SUBTROPICAL AGRICULTURE, CHINESE ACADEMY OF SCIENCES, Changsha (CN)

(21) Appl. No.: 19/712,101

(22) Filed: Jun. 18, 2026

Related U.S. Application Data
(63) Continuation of application No. PCT/CN2024/086409, filed on Apr. 7, 2024.

(30) Foreign Application Priority Data
Dec. 19, 2023 (CN) 202311746042.5

(51) Int. Cl. G01N 30/06; G01N 1/28; G01N 1/34; G01N 30/02; G01N 30/30; G01N 30/32

(52) U.S. Cl. CPC G01N 30/06; G01N 1/286; G01N 1/34; G01N 30/30; G01N 30/32; G01N 2001/2866; G01N 2030/025; G01N 2030/062

(57) ABSTRACT

A method for determining the content of short-chain fatty acids in intestinal contents or feces is provided. The method includes a step of sample pre-treatment, wherein acetone is firstly used as an extraction solvent to extract short-chain fatty acids in a sample of intestinal contents or feces, and then the acetone extract of short-chain fatty acids obtained by the extraction is separated and purified by a solid phase extraction column. C8 and SAX are used as the packing material of the solid phase extraction column. The method is characterized by high recovery, low detection limit and short time consumption.

### CROSS REFERENCE OF THE RELATED APPLICATIONS

This application is a continuation application of International Application No. PCT/CN2024/086409, filed on Apr. 7, 2024, which is based upon and claims priority to Chinese Patent Application No. 202311746042.5, filed on Dec. 19, 2023, the entire contents of which are incorporated herein by reference.

### TECHNICAL FIELD

The present disclosure relates to the field of quantitative detection technology, in particular to a method for determining the content of short-chain fatty acids in intestinal contents or feces.

### BACKGROUND

Short-chain fatty acids (SCFAs) are produced through fermenting unabsorbed components of foods by the intestinal microbiota in the large intestine. The most abundant SCFAs are acetic acid, propionic acid and butyric acid, accounting for 90%-95% of the total SCFAs in the colon. They are mainly derived from carbohydrates, while some amino acids (especially valine, leucine, and isoleucine) can be converted into branched-chain SCFAs such as isobutyric acid and isovaleric acid, which contribute slightly to the total SCFAs. The presence of SCFA in the intestine has some advantages, e.g., lowering the lumen pH, which facilitates nutrient absorption and reduces the formation of some pathogenic microorganisms.

Currently, there are several analytical methods available for the detection of SCFA, e.g., gas chromatography (GC), high performance liquid chromatography (HPLC), capillary electrophoresis (CE), or nuclear magnetic resonance (NMR). Among them, GC is the most commonly used technology because of the volatility of SCFA and the high sensitivity, good resolution and relatively low cost of the technology and sample pre-treatment. GC can be coupled with a flame ionization detector (FID). In addition, coupling of GC to a mass spectrometer (MS) can further improve the selectivity and sensitivity of the method. Prior to SCFA analysis, sample pre-treatment usually includes extraction, and in some cases, purification and/or derivatization. CN110045040A, CN116124905A, etc. disclose methods for determining the content of short-chain fatty acids. However, the accuracy and efficiency of the aforesaid methods need to be improved.

### SUMMARY

In order to solve the problems in the prior art, the present disclosure provides a method for determining the content of short-chain fatty acids in intestinal contents or feces.

The present disclosure provides a method for determining the content of short-chain fatty acids in intestinal contents or feces, including a step of sample pre-treatment, wherein acetone is firstly used as an extraction solvent to extract short-chain fatty acids in a sample of intestinal contents or feces, and the acetone extract of short-chain fatty acids obtained by the extraction is separated and purified by a solid phase extraction column, wherein C8 and SAX are used as the packing material of the solid phase extraction column.

Wherein, C8 is a silica gel bonded octyl, and SAX is a strong anion exchange packing material bonded with quaternary amine functional groups.

Preferably, the mass ratio between C8 and SAX is 1:3~3:1. The packing material is filled in sections with the C8 packing material at the top and the SAX packing material at the bottom, i.e., when the extract passes through the solid phase extraction column, it firstly passes through the C8 packing material and then through the SAX packing material. Wherein, the mass ratio between C8 and SAX can be any value within the range of 1:3~3:1, e.g., 1:3, 1.5:2.5, 2:2, 2.5:1.5 or 3:1, but is not limited to the values listed above, and other unlisted values within the aforesaid range of values are also applicable.

The present disclosure employs acetone to extract short-chain fatty acids. After extraction and purification through solid phase extraction column with a specific packing material, the sample solution with high purity, less impurities and good resolution can be obtained. This facilitates subsequent gas chromatographic detection and gives a rapid and precise content of short-chain fatty acids.

In some embodiments of the present invention, the amount of the sample of intestinal contents or feces is 50-150 mg, e.g., 50 mg, 80 mg or 100 mg. The amount of acetone is 1 mL.

In some embodiments of the present invention, the extraction includes: adding 50 mg-150 mg of the sample of intestinal contents or feces into a centrifuge tube, adding 300 μL-400 μL acetone for grinding, and adding additional 600 μL-700 μL acetone and making the sample uniform by vortex, and high-speed centrifuging the sample at 4 °C, 10000 g-12000 g for 10 min-15 min after the vortex.

Preferably, the samples of intestinal contents or feces are stored at −80 °C prior to treatment to avoid volatilization and loss of short-chain fatty acids.

Preferably, an electric grinding rod is used independently for each sample. The used grinding rod is soaked in 75% ethanol, and washed and sterilized in an autoclave after finishing the test, and is then dried and stored for later use.

In some embodiments of the present invention, the separation and purification include: firstly activating the solid phase extraction column with acetone, removing the residual acetone by blowing dry, and adding the acetone extract of short-chain fatty acids into the solid phase extraction column, wherein the eluate is a sample solution of the short-chain fatty acids.

In some embodiments of the present invention, the method further includes: determining the content of short-chain fatty acids by conducting gas chromatography on the sample solution obtained from the sample pre-treatment.

In some embodiments of the present invention, the gas chromatography is conducted in temperature programming. The temperature programming is as follows: keeping the initial temperature of the column at 50 °C for 1 min, warming at 15 °C/min to 120 °C which is kept for 0 min, and warming at 6 °C/min to 200 °C which is kept for 0 min, totally running for 19 min. Finally, the post-running temperature was increased to 235 °C for 3 min.

In some embodiments of the present invention, the detection condition for the gas chromatography is as follows: using Agilent DB-FFAP (30 m, 0.25 mm×0.25 μm) as the chromatographic column and N₂ as the carrier gas, the flow rate of 1 mL/min, the pressure of 11.258 psi, the injector port temperature of 280 °C, the FID detector temperature of 250 °C, the H₂ flow rate of 40 mL/min, the air flow rate of 300 mL/min, the N₂ make-up gas flow rate of 25 mL/min; the sample size of 1 μL, and using water as wash solvent A and acetone as wash solvent B.

Preferably, the injector port liner of the gas chromatograph is ultra-high inert, shunted, with low-pressure drop, and with glass wool (Agilent, 5190-3165). It needs to be checked whether the liner becomes dirty which is easy to cause impurity peak after injecting about 50 samples. At this point, the dirty glass wool can be gently removed by using a pointed tweezer, while the liner can still be used.

Preferably, after injecting about 50 samples, the injector port septum of the gas chromatograph needs to be replaced with a new one in time to avoid instrument leakage error reporting and contamination of the liner.

Preferably, the method of cleaning the chromatographic column at a high temperature needs to be set after injecting about 50 samples. 2 needles of acetone are injected as blank to avoid interference with the results by the impurity peak residues. The method for high-temperature cleaning chromatography is as follows: the Agilent 7820A gas chromatograph injector port heater of 280 °C, the pressure of 11.258 psi, the split ratio of 10:1; using Agilent DB-FFAP (30 m, 0.25 mm×0.25 μm) column as the chromatographic column and N₂ as the carrier gas, the flow rate of 1 mL/min, the pressure of 11.258 psi, the column oven of 50 °C for 1 min which warming at 5 °C/min to 150 °C kept for 10 min, and warming at 5 °C/min to 240 °C kept for 10 min, totally running for 59 min; the FID detector, heated at 250 °C, with the H₂ flow rate of 40 mL/min, the air flow rate of 300 mL/min, the make-up gas flow rate (N₂) of 25 mL/min; the GC autosampler, with a sample size of 1 μL, using water as wash solvent A and acetone as wash solvent B, which is washed twice by A and B with the maximum volume before injection, respectively. The sample was washed with 4 μL twice and sucked for 3 times.

The short-chain fatty acids disclosed herein include acetic acid, propionic acid, isobutyric acid, n-butyric acid, isovaleric acid, n-valeric acid and caproic acid.

The present disclosure also provides a use of the method for determining the content of short-chain fatty acids in intestinal contents or feces in the preparation of a detection kit of the content of short-chain fatty acids.

The present disclosure provides a method for determining the content of short-chain fatty acids in intestinal contents or feces. The short-chain fatty acids are extracted by using acetone, and then purified by a solid phase extraction column with a specific packing material after the extraction, which increases the gasification time of the sample at the injector port of the gas chromatograph. The method is simple, rapid, efficient, and capable of accurately determining the content of short-chain fatty acids in intestinal contents or feces.

### BRIEF DESCRIPTION OF THE DRAWINGS

FIG. 1 shows the gas chromatographic detection of the mixed standard of short-chain fatty acids at L3 concentration.

FIG. 2 shows the gas chromatographic detection of short-chain fatty acids in mouse cecum contents.

FIG. 3 shows the gas chromatographic detection of short-chain fatty acids in mouse feces.

FIG. 4 shows the gas chromatographic detection of short-chain fatty acids in pig cecum contents.

FIG. 5 shows the gas chromatographic detection of short-chain fatty acids in pig feces.

FIG. 6 shows the gas chromatographic detection of short-chain fatty acids in bee intestinal contents.

### DETAILED DESCRIPTION OF THE EMBODIMENTS

In one aspect, the present disclosure provides a method for determining the content of short-chain fatty acids in intestinal contents or feces, including a step of sample pre-treatment, wherein acetone is firstly used as an extraction solvent to extract short-chain fatty acids in a sample of intestinal contents or feces, and the acetone extract of short-chain fatty acids obtained by the extraction is separated and purified by a solid phase extraction column. C8 and SAX are used as the packing material of the solid phase extraction column.

In some embodiments of the present invention, the mass ratio between C8 and SAX is 1:3~3:1. The packing material is filled in sections with the C8 packing material at the top and the SAX packing material at the bottom.

In some embodiments of the present invention, the amount of the sample of intestinal contents or feces sample is 50-150 mg. The amount of acetone is 1 mL.

In some embodiments of the present invention, the extraction includes: adding 50 mg-150 mg of the sample of intestinal contents or feces into a centrifuge tube, adding 300 μL-400 μL acetone for grinding, and adding additional 600 μL-700 μL acetone and making the samples uniform by vortex, and high-speed centrifuging the sample at 4 °C, 10000 g-12000 g for 10 min-15 min after the vortex.

In some embodiments of the present invention, the separation and purification include: firstly activating the solid phase extraction column with acetone, removing the residual acetone by blowing dry, and adding the acetone extract of short-chain fatty acids into the solid phase extraction column, wherein the eluate is a sample solution of the short-chain fatty acids;

In some embodiments of the present invention, the method further includes: determining the content of short-chain fatty acids by conducting gas chromatography on the sample solution obtained from the sample pre-treatment.

In some embodiments of the present invention, gas chromatography is conducted in temperature programming. The temperature programming is as follows: keeping the initial temperature of the column at 50 °C for 1 min, warming at 15 °C/min to 120 °C which is kept for 0 min, and warming at 6 °C/min to 200 °C which is kept for 0 min, totally running for 19 min. Finally, the post-running temperature was increased to 235 °C for 3 min.

In some embodiments of the present invention, the detection condition for the gas chromatography is as follows: using Agilent DB-FFAP as the chromatographic column and N₂ as the carrier gas, the flow rate of 1 mL/min, the pressure of 11.258 psi, the injector port temperature of 280 °C, the FID detector temperature of 250 °C, the H₂ flow rate of 40 mL/min, the air flow rate of 300 mL/min, the N₂ make-up gas flow rate of 25 mL/min; the sample size of 1 μL, using water as wash solvent A and acetone as wash solvent B.

In some embodiments of the present invention, the short chain fatty acids are acetic acid, propionic acid, isobutyric acid, n-butyric acid, isovaleric acid, n-valeric acid and caproic acid.

The present disclosure also provides a use of the method for determining the content of short-chain fatty acids in intestinal contents or feces in the preparation of a detection kit of the content of short-chain fatty acids. In other respect, the present disclosure provides a method for determining the content of short-chain fatty acids in intestinal contents or feces, including a step of sample pre-treatment, wherein acetone is firstly used as the extraction solvent to extract short-chain fatty acids in a sample of intestinal contents or feces, and the acetone extract of short-chain fatty acids obtained by the extraction is separated and purified by a solid phase extraction column. C8 and SAX are used as the packing material of the solid phase extraction column. The mass ratio between C8 and SAX is 1:3~3:1. The packing material is filled in sections with the C8 packing material at the top and the SAX packing material at the bottom;

The procedure for the extraction is as follows: adding 50 mg-150 mg of the sample of intestinal contents or feces into a centrifuge tube, adding additional 300 μL-400 μL acetone for grinding, and adding 600 μL-700 μL acetone and making the sample uniform by vortex, and high-speed centrifuging the sample at 4 °C, 10000 g-12000 g for 10 min-15 min after the vortex;

The procedure for the separation and purification is as follows: firstly activating the solid phase extraction column with acetone, removing the residual acetone by blowing dry, and adding the acetone extract of short-chain fatty acids into the solid phase extraction column, wherein the eluate is a sample solution of the short-chain fatty acids;

The method further includes: determining the content of short-chain fatty acids by conducting gas chromatography on the sample solution obtained from the sample pre-treatment. The chromatographic column used in the gas chromatography is Agilent DB-FFAP, and the detector is FID;

The short chain fatty acids are acetic acid, propionic acid, isobutyric acid, n-butyric acid, isovaleric acid, n-valeric acid and caproic acid.

In some embodiments of the present invention, gas chromatography is conducted in temperature programming. The temperature programming is as follows: keeping the initial temperature of the column at 50 °C for 1 min, warming at 15 °C/min to 120 °C which is kept for 0 min, and warming at 6 °C/min to 200 °C which is kept for 0 min, totally running for 19 min. Finally, the post-running temperature was increased to 235 °C for 3 min.

In some embodiments of the present invention, the detection condition for the gas chromatography is as follows: using Agilent DB-FFAP (30 m, 0.25 mm×0.25 μm) as the chromatographic column and N₂ as the carrier gas, the flow rate of 1 mL/min, the pressure of 11.258 psi, the injector port temperature of 280 °C, the FID detector temperature of 250 °C, the H₂ flow rate of 40 mL/min, the air flow rate of 300 mL/min, the N₂ make-up gas flow rate of 25 mL/min; the sample size of 1 μL, using water as wash solvent A and acetone as wash solvent B.

In order to make the purpose, the technical solution and the advantages of the present disclosure clearer, the technical solution of the present disclosure will be described clearly and completely as follows. Obviously, the embodiments described are a part of the embodiments of the present disclosure, but not all embodiments. Based on the embodiments in the present disclosure, all other embodiments obtained by those of ordinary skill in the art without making creative labor fall within the scope of protection of the present disclosure.

If no specific technology or condition is indicated in the embodiments, it is performed in accordance with the technology or condition described in the literature in the art, or in accordance with the product specification. The reagents or instruments used without indicating the manufacturer are conventional products that can be purchased through regular channels.

### Method Verification

### 1. Determination of Standard Curves, Detection Limits and Quantitation Limits

Preparation of the standards of short-chain fatty acids: 60 μL acetic acid, propionic acid, isobutyric acid, butyric acid, isovaleric acid, valeric acid and caproic acid were weighed respectively into the same 10 Ml volumetric bottle, and the weight of each acid was recorded; then acetone was added and made up to 10 Ml. The molar concentration of each acid was calculated. The results are shown in Table 1. The stock solution of short-chain fatty acids can be stored at −20 °C for one month.

TABLE 1
Preparation of the stock solution of short-chain fatty acids

| Standards | Molecular mass | Weight (mg) | Final concentration (Mm) |
|---|---|---|---|
| Acetic acid | 60.052 | 64.5 | 107.4069 |
| Propionic acid | 74.08 | 59.5 | 80.3186 |
| Isobutyric acid | 88.105 | 55.6 | 63.1065 |
| Butyric acid | 88.105 | 57.2 | 64.9225 |
| Isovaleric acid | 102.132 | 54.7 | 53.5581 |
| Valeric acid | 102.132 | 55.5 | 54.3414 |
| Caproic acid | 116.158 | 53.3 | 45.8858 |

L1: 990 μL acetone + 10 μL SCFA stock solution (Table 1), vortexed to mix uniformly;
L2: 500 μL acetone + 500 μL L1, vortexed to mix uniformly;
L3: 990 μL acetone + 10 μL L1, vortexed to mix uniformly;
L4: 990 μL acetone + 10 μL L2, vortexed to mix uniformly;
L5: 990 μL acetone + 10 μL L3, vortexed to mix uniformly;
L6: 990 μL acetone + 10 μL L5, vortexed to mix uniformly.

TABLE 2
Preparation of gradient standards of short-chain fatty acids

| Standards | L1 (μM) | L2 (μM) | L3 (μM) | L4 (μM) | L5 (μM) | L6 (μM) |
|---|---|---|---|---|---|---|
| Acetic acid | 1074.069 | 537.0345 | 107.4069 | 53.7035 | 10.7407 | 1.0741 |
| Propionic | 803.186 | 401.593 | 80.3186 | 40.1593 | 8.0319 | 0.8032 |
| acid | | | | | | |
| Isobutyric | 631.065 | 315.5325 | 63.1065 | 31.5533 | 6.3107 | 0.6311 |
| acid | | | | | | |
| Butyric acid | 649.225 | 324.6125 | 64.9225 | 32.4613 | 6.4923 | 0.6492 |
| Isovaleric | 535.581 | 267.7905 | 53.5581 | 26.7791 | 5.3558 | 0.5356 |
| acid | | | | | | |
| Valeric acid | 543.414 | 271.707 | 54.3414 | 27.1707 | 5.4341 | 0.5434 |
| Caproic | 458.858 | 229.429 | 45.8858 | 22.9429 | 4.5886 | 0.4589 |
| acid | | | | | | |

The standard analytical substance of each concentration was measured in triplicate, and 3 times of the baseline noise was taken as the lowest limit of detection (LOD) for each short-chain fatty acid. 10 times of the baseline noise was taken as the lowest limit of quantification (LOQ) for each short-chain fatty acid. It can be seen in Table 3.

TABLE 3
Response time, LODs, LOQs and standard curves of
short-chain fatty acids in the standard solution

| | Response | | | | |
|---|---|---|---|---|---|
| | time | Lowest | Lowest | | Correlation |
| Analytes | (min) | LOD | LOQ | Standard curve | coefficient |
| Acetic | 7.670254 | 0.36 | 1.21 | y = 0.0117x + 0.1529 | 0.9998 |
| acid | | | | | |
| Propionic | 8.661254 | 0.15 | 0.76 | y = 0.0237x + 0.2710 | 0.9998 |
| acid | | | | | |
| Isobutyric | 8.990053 | 0.15 | 0.51 | y = 0.0344x + 0.2452 | 0.9999 |
| acid | | | | | |
| Butyric | 9.780011 | 0.13 | 0.42 | y = 0.0334x + 0.1925 | 0.9998 |
| acid | | | | | |
| Isovaleric | 10.32313 | 0.11 | 0.38 | y = 0.0426x + 0.2589 | 0.9998 |
| acid | | | | | |
| Valeric | 11.28346 | 0.13 | 0.43 | y = 0.0437x + 0.2537 | 0.9998 |
| acid | | | | | |
| Caproic | 12.83637 | 0.15 | 0.49 | y = 0.0526x + 0.2480 | 0.9998 |
| acid | | | | | |

### 2. Reproducibility Test

The standard at L3 concentration was detected 3 times in parallel, and the precision (RSD, %) was calculated to observe the reproducibility. The standard at L3 concentration was injected in the morning, the afternoon and the evening, and the precision (RSD, %) was calculated to observe the intraday stability. The standard at L3 concentration was injected on day 1, day 2 and day 3, and the precision (RSD, %) was calculated to observe the interday stability. The results are shown in Table 4.

TABLE 4
Reproducibility test results of standard at L3 concentration

| | | Peak area | | | |
|---|---|---|---|---|---|
| | | 1 | 2 | 3 | RSD (%) |
| Reproduc- | Acetic acid | 8.63 | 9.93 | 10.59 | 0.8 |
| ibility | Propionic acid | 15.77 | 16.12 | 17.72 | 0.85 |
| | Isobutyric acid | 18.78 | 19.58 | 19.82 | 0.44 |
| | Butyric acid | 17.89 | 18.35 | 18.78 | 0.36 |
| | Isovaleric acid | 18.78 | 19.27 | 19.67 | 0.36 |
| | Valeric acid | 19.82 | 20.44 | 20.68 | 0.36 |
| | Caproic acid | 20.96 | 21.51 | 21.82 | 0.36 |
| | | Morning | Afternoon | Evening | RSD (%) |
| Intraday | Acetic acid | 10.97 | 9.15 | 8.52 | 1.04 |
| stability | Propionic acid | 17.14 | 14.62 | 15.34 | 1.06 |
| | Isobutyric acid | 20.36 | 18.33 | 17.59 | 1.17 |
| | Butyric acid | 19.27 | 16.36 | 17.62 | 1.19 |
| | Isovaleric acid | 20.43 | 17.37 | 18.16 | 1.30 |
| | Valeric acid | 21.62 | 18.68 | 19.23 | 1.28 |
| | Caproic acid | 22.53 | 19.98 | 20.71 | 1.07 |
| | | D 1 | D 2 | D 3 | RSD (%) |
| Interday | Acetic acid | 9.77 | 8.25 | 10.86 | 1.07 |
| stability | Propionic acid | 15.36 | 14.31 | 17.27 | 1.23 |
| | Isobutyric acid | 18.21 | 17.13 | 19.29 | 0.88 |
| | Butyric acid | 17.34 | 18.93 | 19.62 | 0.95 |
| | Isovaleric acid | 18.69 | 17.54 | 20.31 | 1.14 |
| | Valeric acid | 19.32 | 18.61 | 21.43 | 1.21 |
| | Caproic acid | 20.53 | 19.64 | 22.49 | 1.19 |

It can be seen from Table 4 that after the injection of 3 standards of short-chain fatty acids at L3 concentration, the RSDs of the peak area were in the range of 0.36%-0.85%, indicating good reproducibility and precision of the instrumental method. The RSDs of the peak area were in the range of 1.04%-1.30% after the determination of the standard of short-chain fatty acids at L3 concentration in the morning, the afternoon and the evening, respectively, indicating that the chromatographic method has good intraday stability. The RSDs of the peak area were in the range of 0.88%-1.23% after the determination of the standard of short-chain fatty acids at L3 concentration on day 1, day 2 and day 3, respectively, indicating that the chromatographic method had good interday stability.

### 3. Recovery Determination

### (1) Matrix Sample Obtainment:

The pig feces were dried and ground at a high temperature, and crudely extracted with acetone. After centrifugation, the supernatant was discarded to remove the short-chain fatty acids in the feces. Then the sediment was dried at high temperature to obtain the fecal matrix sample.

(2) Dissolution of Matrix Sample Spiked with Standard:

H1: 50 mg fecal matrix sample+990 μL acetone+10 μL SCFA stock solution (Table 1), vortexed to mix uniformly;

H2: 50 mg fecal matrix sample+500 μL acetone+500 μL L1, vortexed to mix uniformly;

H3: 50 mg fecal matrix sample 990 μL acetone+10 μL L1, vortexed to mix uniformly;

H4: 50 mg fecal matrix sample+990 μL acetone+10 μL L2, vortexed to mix uniformly;

H5: 50 mg fecal matrix sample+990 μL acetone+10 μL L3, vortexed to mix uniformly;

The sample was placed symmetrically in a high-speed centrifuge at 4 °C, 12000 g for 10 min.

### (3) Purification of Spiked Matrix Sample:

The C8+SAX solid phase extraction column was activated with 1 mL acetone (wherein the mass ratio of C8:SAX=1:1, with C8 at the top and SAX at the bottom), and the residual acetone was removed by blowing dry; a clean 10 mL centrifuge tube was placed under the solid phase extraction column. The acetone extract of the spiked matrix sample was added into the solid phase extraction column. The impurities were adsorbed into the packing material of the solid phase extraction column, and the sample flowing out was short-chain fatty acid.

(4) Detection of spiked matrix sample:

Chromatographic analysis was performed by Agilent 7820A gas chromatography and Agilent DB-FFAP gas chromatographic columns. The condition for the gas phase analysis was as follows: the injector port heater was 280 °C with the pressure of 11.258 psi and split ratio of 10:1; the chromatographic column was Agilent DB-FFAP (30 m, 0.25 mm×0.25 μm), using N₂ as the carrier gas. The flow rate was 1 mL/min, and the pressure was 11.258 psi. The column oven was kept at 50 °C for 1 min, and was warmed at 15 °C/min to 120 °C which was kept for 0 min. Then it was warmed at 6 °C/min to 200 °C which was kept for 0 min. It ran for 19 min in total; then it post-ran at 235 °C for 3 min; FID detector was heated at 250 °C, with H₂ flow rate of 40 mL/min, air flow rate of 300 mL/min, and make-up gas flow rate (N₂) of 25 mL/min; the injection volume of GC autosampler was 1 μL, using water as wash solvent A and acetone as wash solvent B. Before injection, it was washed twice by A and B with the maximum volume, respectively. The sample was washed with 4 μL twice and sucked for 3 times.

### (5) Calculation Formula of Recovery:

Recovery=(spiked matrix concentration−matrix concentration)/(added standard concentration)×100%. The results are shown in Table 5.

TABLE 5

| | H1 | H2 | H3 | H4 | H5 |
|---|---|---|---|---|---|
| Acetic | 86.45 ± 0.69 | 79.25 ± 0.24 | 80.16 ± 1.11 | 117.19 ± 1.34 | 137.83 ± 1.23 |
| acid | | | | | |
| Propionic | 90.56 ± 0.02 | 86.18 ± 1.53 | 81.94 ± 0.72 | 101.2 ± 0.97 | 116.04 ± 1.95 |
| acid | | | | | |
| Isobutyric | 95.32 ± 0.28 | 94.86 ± 1.97 | 95.61 ± 0.50 | 89.58 ± 0.94 | 98.34 ± 0.86 |
| acid | | | | | |
| Butyric | 91.30 ± 0.01 | 86.91 ± 1.68 | 82.04 ± 0.90 | 107.51 ± 1.46 | 125.42 ± 1.92 |
| acid | | | | | |
| Isovaleric | 93.53 ± 0.11 | 91.05 ± 1.97 | 88.25 ± 0.82 | 96.34 ± 1.19 | 106.54 ± 0.91 |
| acid | | | | | |
| Valeric | 92.26 ± 0.01 | 89.61 ± 1.92 | 86.36 ± 0.66 | 95.01 ± 1.75 | 106.68 ± 1.37 |
| acid | | | | | |
| Caproic | 93.84 ± 0.06 | 93.25 ± 1.85 | 93.41 ± 0.68 | 89.17 ± 1.94 | 100.73 ± 1.59 |
| acid | | | | | |

The results in Table 5 show that the spiked recoveries of different concentrations of short-chain fatty acids in the treated pig feces are 81.94%-137.83%, indicating that the method has good recovery, and accurate and reliable results.

### Example 1

The present example provides a method for determining the content of short-chain fatty acids in mouse feces and pig feces, respectively, including the following steps:
1) Sample dissolution: 50 mg of feces was weighted into a 1.5 mL centrifuge tube. After adding 300 μL acetone, the feces residue was fully ground with an electric grinding rod. Then additional 700 μL acetone was added for vortexing the sample uniformly; the sample was placed symmetrically in a high-speed centrifuge for centrifugation at 4 °C, 12000 g for 10 min.
2) Sample purification: The C8+SAX solid phase extraction column was activated with 1 mL acetone (wherein the mass ratio of C8:SAX=1:1, with C8 at the top and SAX at the bottom), and the residual acetone was removed by blowing dry; a clean 10 mL centrifuge tube was placed under the solid phase extraction column. The acetone extract of the spiked matrix sample was added into the solid phase extraction column. The impurities were adsorbed into the packing material of the solid phase extraction column, and the sample flowing out was short-chain fatty acid.
3) Sample detection: Chromatographic analysis was performed by Agilent 7820A gas chromatography and Agilent DB-FFAP gas chromatographic columns. The condition for the gas phase analysis was as follows: the injector port heater was 280 °C with the pressure of 11.258 psi and split ratio of 10:1; the chromatographic column was Agilent DB-FFAP (30 m, 0.25 mm×0.25 μm), using N₂ as the carrier gas. The flow rate was 1 mL/min, and the pressure was 11.258 psi. The column oven was kept at 50 °C for 1 min, and was warmed at 15 °C/min to 120 °C which was kept for 0 min. Then it was warmed at 6 °C/min to 200 °C which was kept for 0 min. It ran for 19 min in total. Then it post-ran at 235 °C for 3 min; the FID detector was warmed at 250 °C, with the H₂ flow rate of 40 mL/min, the air flow rate of 300 mL/min, and the make-up gas flow rate (N₂) of 25 mL/min; the injection volume of GC autosampler was 1 μL, using water as wash solvent A and acetone as wash solvent B. Before injection, it was washed twice by A and B with the maximum volume, respectively. The sample was cleaned with 4 μL twice and sucked for 3 times.

### Example 2

The present example provides a method for determining the content of short-chain fatty acids in mouse cecum contents, pig cecum contents and bee intestinal contents, respectively, including the following steps:
1) Sample obtainment: The intestines of mice, pigs or bees were dissected on the operating table using clean scissors and tweezers. The extracted intestinal contents were rapidly placing in liquid nitrogen, and finally transferred to −80 °C for sample storage.
2) 50 mg of intestinal contents was weighted into a 1.5 mL centrifuge tube. After adding 300 μL acetone, the feces residue was fully ground with an electric grinding rod. Then 700 μL acetone was added for vortexing the sample uniformly; the sample was placed symmetrically in a high-speed centrifuge for centrifugation at 4 °C, 12000 g for 10 min.
3) Sample purification: 1 mL acetone was used to activate the C8+SAX solid-phase extraction column (where the mass ratio of C8:SAX=1:1, with C8 on top and SAX on bottom), and the residual acetone was removed by blowing dry; A clean 10 mL centrifuge tube was placed under the solid phase extraction column, and the acetone extraction solution of the sample was added to the solid phase extraction column, and the impurities were adsorbed into the packing material of the solid phase extraction column, and the sample flowing out was short-chain fatty acid.
4) Sample detection: Chromatographic analysis was performed by Agilent 7820A gas chromatography and Agilent DB-FFAP gas chromatographic columns. The condition for the gas phase analysis was as follows: the injector port heater was 280 °C with the pressure of 11.258 psi and split ratio of 10:1; the chromatographic column was Agilent DB-FFAP (30 m, 0.25 mm×0.25 μm), using N₂ as the carrier gas. The flow rate was 1 mL/min, and the pressure was 11.258 psi. The column oven was kept at 50 °C for 1 min, and was warmed at 15 °C/min to 120 °C which was kept for 0 min. Then it was warmed at 6 °C/min to 200 °C which was kept for 0 min. It ran for 19 min in total. Then it post-ran at 235 °C for 3 min; the FID detector was warmed at 250 °C, with the H₂ flow rate of 40 mL/min, the air flow rate of 300 mL/min, and the make-up gas flow rate (N₂) of 25 mL/min; the injection volume of GC autosampler was 1 μL, using water as wash solvent A and acetone as wash solvent B. Before injection, it was washed twice by A and B with the maximum volume, respectively. The sample was washed with 4 μL twice and sucked for 3 times.

The results for determining the content of short-chain fatty acids in mouse intestinal contents, mouse feces, pig intestinal contents, pig feces and bee intestinal contents by the method disclosed herein are shown in Table 6.

TABLE 6

| | | Short-chain fatty acid (umol/g) | | | | | | |
|---|---|---|---|---|---|---|---|---|
| | | Acetic | Propionic | Isobutyric | Butyric | Isovaleric | Valeric | Caproic |
| | | acid | acid | acid | acid | acid | acid | acid |
| Mouse | 1 | 28.52 | 8.25 | 0.93 | 17.04 | 1.24 | 1.24 | 0.00 |
| intestinal | 2 | 16.40 | 8.33 | 1.11 | 8.17 | 1.53 | 1.14 | 0.00 |
| contents | 3 | 13.21 | 6.43 | 0.89 | 6.68 | 1.40 | 1.01 | 0.00 |
| | 4 | 18.99 | 7.06 | 0.73 | 11.09 | 1.06 | 0.94 | 0.00 |
| | 5 | 20.13 | 8.34 | 1.08 | 11.59 | 1.47 | 1.42 | 0.00 |
| | 6 | 23.24 | 8.37 | 1.05 | 13.50 | 1.42 | 1.43 | 0.00 |
| | 7 | 26.35 | 6.77 | 0.93 | 15.99 | 1.22 | 1.22 | 0.00 |
| Mouse | 1 | 34.61 | 9.47 | 0.44 | 18.58 | 0.43 | 0.51 | 0.06 |
| feces | 2 | 29.80 | 7.39 | 0.41 | 21.64 | 0.31 | 0.57 | 0.00 |
| | 3 | 26.56 | 7.97 | 0.47 | 17.36 | 0.49 | 0.42 | 0.00 |
| | 4 | 27.00 | 7.08 | 0.54 | 17.34 | 0.58 | 0.40 | 0.00 |
| | 5 | 20.52 | 7.89 | 0.31 | 12.15 | 0.23 | 0.36 | 0.00 |
| | 6 | 17.72 | 5.72 | 0.40 | 11.48 | 0.39 | 0.35 | 0.00 |
| | 7 | 14.41 | 7.03 | 0.55 | 6.71 | 0.58 | 0.68 | 0.03 |
| | 8 | 14.69 | 3.47 | 0.19 | 5.24 | 0.28 | 0.00 | 0.00 |
| Pig | 1 | 14.51 | 9.04 | 0.56 | 3.81 | 0.71 | 4.46 | 0.21 |
| intestinal | 2 | 12.47 | 10.20 | 0.69 | 9.25 | 0.82 | 3.95 | 0.38 |
| contents | 3 | 13.41 | 11.46 | 0.48 | 10.75 | 0.62 | 3.05 | 0.00 |
| | 4 | 13.62 | 9.68 | 0.66 | 13.73 | 0.71 | 5.26 | 0.49 |
| | 5 | 13.39 | 12.93 | 0.75 | 15.04 | 0.73 | 5.37 | 0.00 |
| | 6 | 13.82 | 9.91 | 0.42 | 10.86 | 0.79 | 4.41 | 0.39 |
| Pig feces | 1 | 34.54 | 12.75 | 1.35 | 14.49 | 2.17 | 0.72 | 0.03 |
| | 2 | 35.36 | 8.50 | 0.61 | 24.73 | 0.69 | 0.97 | 0.02 |
| | 3 | 31.35 | 11.66 | 1.44 | 12.71 | 2.20 | 1.02 | 0.00 |
| | 4 | 40.16 | 9.21 | 0.97 | 34.90 | 1.74 | 0.92 | 0.00 |
| | 5 | 18.99 | 11.29 | 1.36 | 9.45 | 2.22 | 1.33 | 0.00 |
| | 6 | 33.32 | 10.11 | 1.35 | 10.60 | 2.24 | 0.86 | 0.00 |
| | 7 | 32.43 | 9.22 | 1.05 | 25.53 | 1.51 | 0.74 | 0.03 |
| | 8 | 32.29 | 8.64 | 1.18 | 14.13 | 1.82 | 0.78 | 0.00 |
| Bee | 1 | 53.76 | 1.32 | 0.18 | 0.15 | 0.30 | 0.00 | 0.10 |
| intestinal | 2 | 77.34 | 1.96 | 0.17 | 0.14 | 0.48 | 0.04 | 0.02 |
| contents | 3 | 85.35 | 2.33 | 0.49 | 0.14 | 0.28 | 0.04 | 0.03 |
| | 4 | 64.80 | 1.52 | 0.17 | 0.09 | 0.23 | 0.00 | 0.00 |
| | 5 | 76.39 | 2.46 | 0.25 | 0.14 | 0.28 | 0.03 | 0.03 |
| | 6 | 71.30 | 1.75 | 0.30 | 0.14 | 0.20 | 0.03 | 0.00 |
| | 7 | 66.23 | 2.21 | 0.83 | 0.22 | 0.66 | 0.03 | 0.03 |
| | 8 | 45.75 | 2.11 | 0.24 | 0.17 | 0.22 | 0.04 | 0.00 |
| | 9 | 49.68 | 1.70 | 0.28 | 0.11 | 0.18 | 0.03 | 0.00 |
| | 10 | 90.13 | 4.15 | 0.59 | 0.27 | 0.24 | 0.03 | 0.05 |
| | 11 | 8.03 | 0.27 | 0.03 | 0.02 | 0.00 | 0.00 | 0.00 |
| | 12 | 76.36 | 0.69 | 0.08 | 0.15 | 0.52 | 0.00 | 0.03 |

As shown in Table 6, acetic acid, propionic acid, isobutyric acid, butyric acid, isovaleric acid, and valeric acid can be detected in both intestinal contents and feces, and caproic acid is partially detected (not all intestinal contents and feces contain caproic acid).

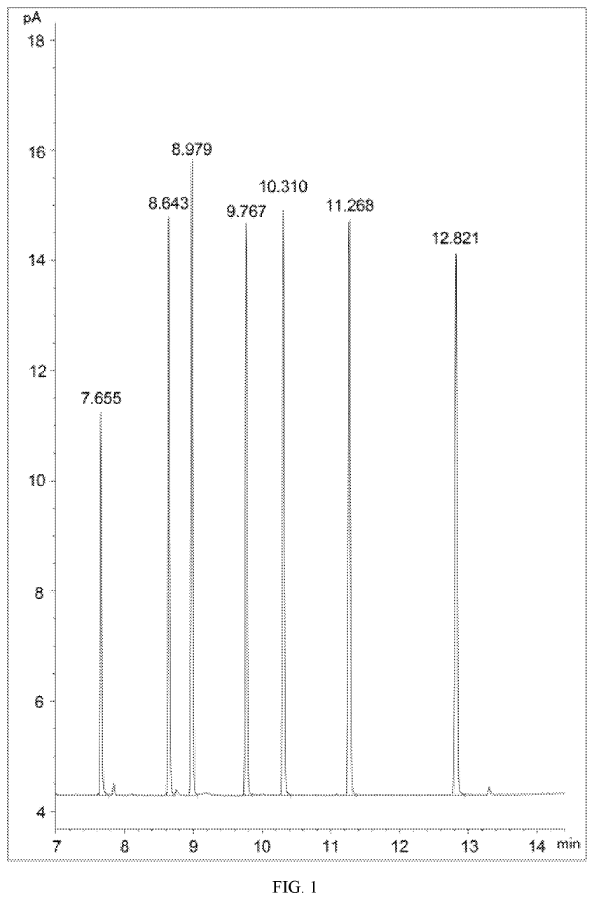

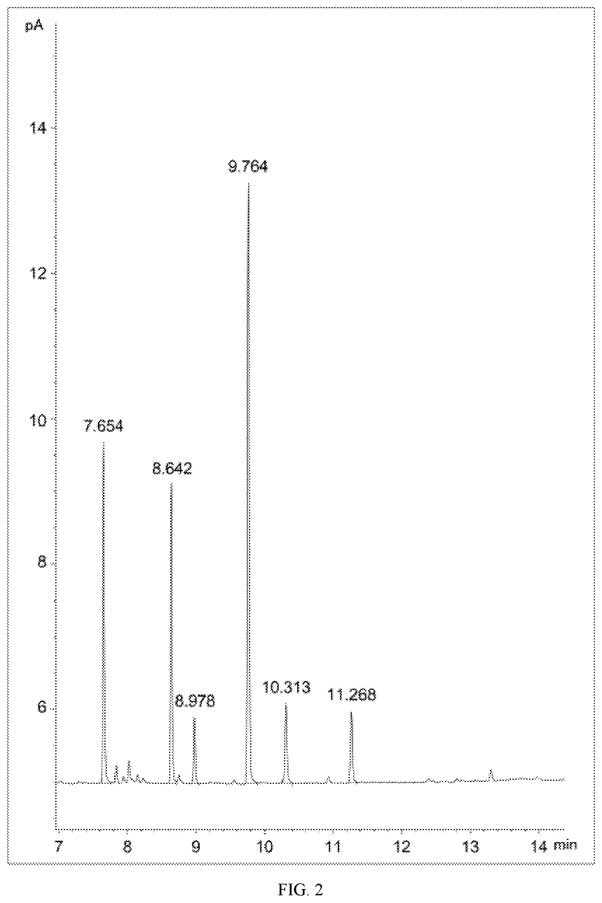

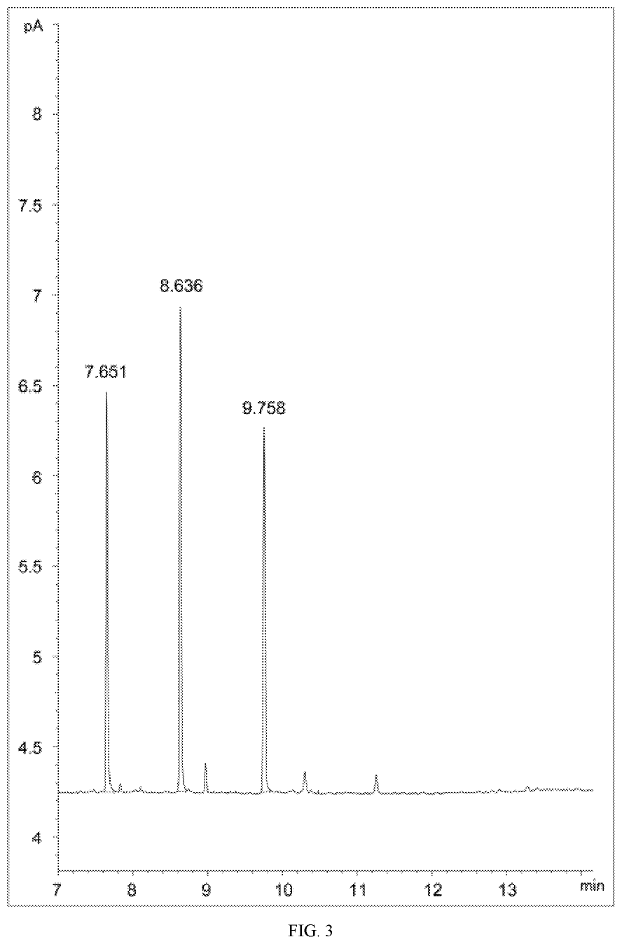

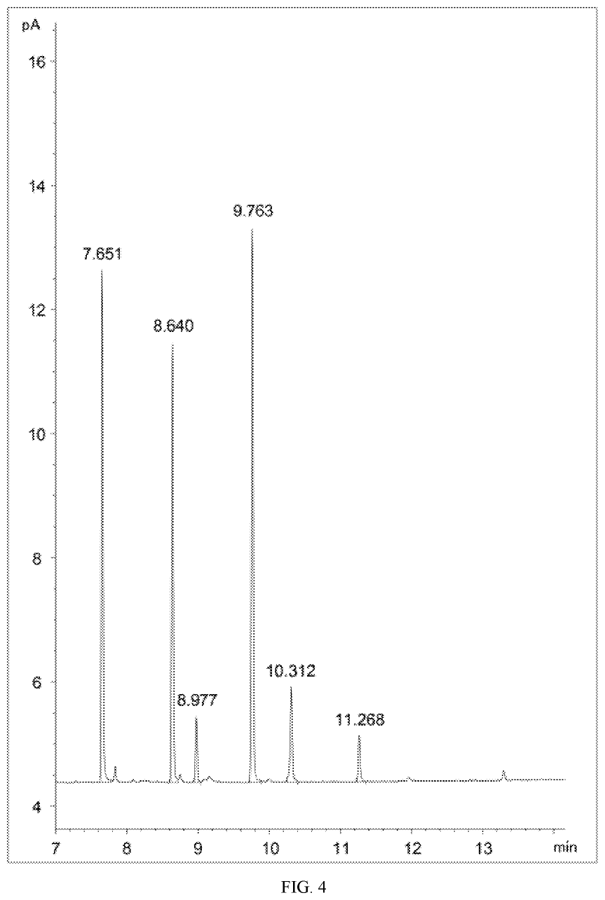

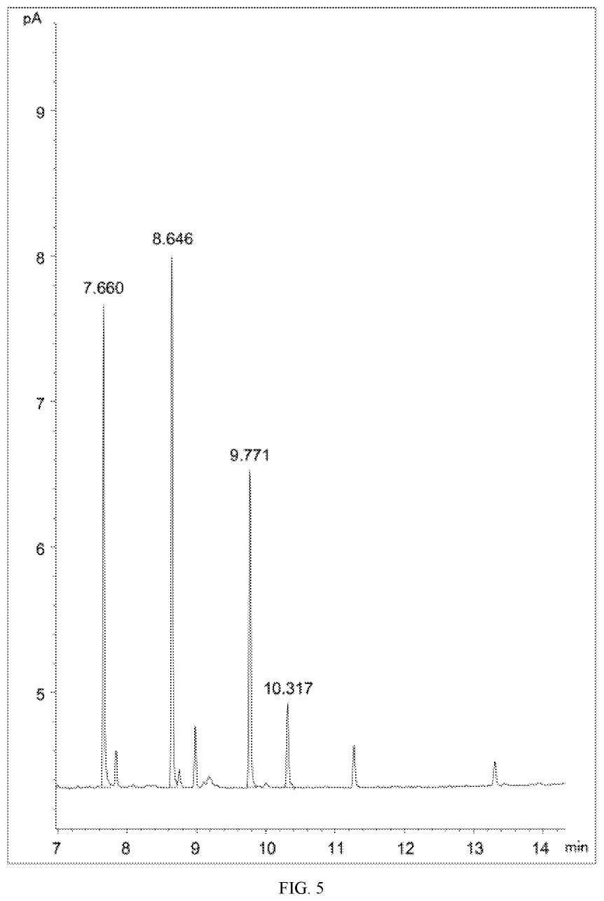

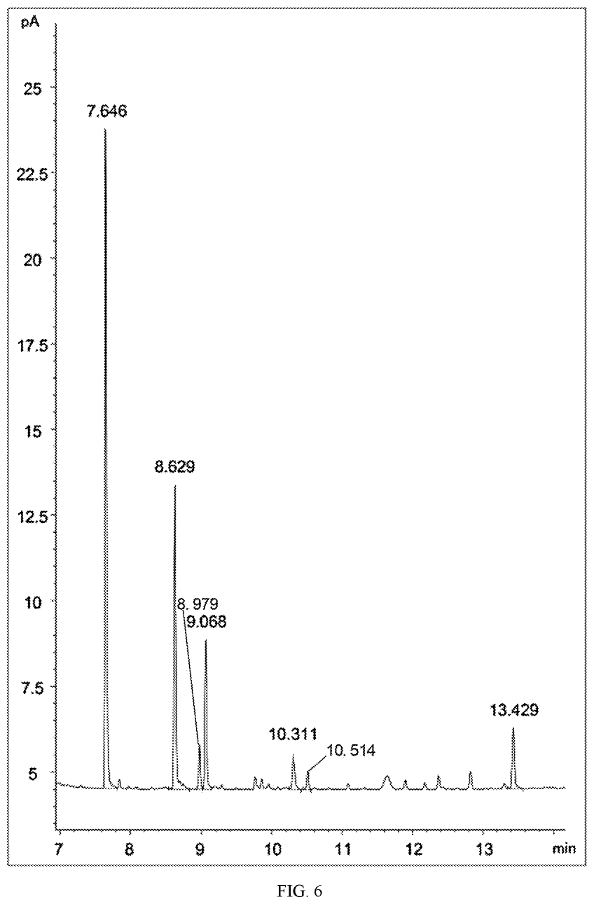

Furthermore, FIG. 1 shows the gas chromatographic detection of the mixed standard of short-chain fatty acids at L3 concentration; FIGS. 2-6 show the gas chromatographic detection of mouse intestinal contents, mouse feces, pig intestinal contents, pig feces and bee intestinal contents, respectively. It can be seen from the detection results of the short-chain fatty acid standard in FIG. 1, the method disclosed herein can ideally separate acetic acid, propionic acid, isobutyric acid, butyric acid, isovaleric acid, valeric acid and caproic acid. It can be seen from FIGS. 2-6 that acetic acid, propionic acid, isobutyric acid, butyric acid, isovaleric acid, valeric acid and caproic acid in intestinal contents or feces can be well detected with few impurities by the method disclosed herein.

### Comparative Example 1

In the present comparative example, short-chain fatty acids were extracted from the pig fecal matrix sample spiked with the mixed standard using acetone, methanol and acetonitrile, respectively, including the following steps:

(1) Dissolution of Matrix Sample Spiked with Standard:

Acetone extract: 50 mg fecal matrix sample+990 μL acetone+10 μL L1, vortexed to mix uniformly;

Methanol extract: 50 mg fecal matrix sample+990 μL methanol+10 μL L1, vortexed to mix uniformly;

Acetonitrile extract: 50 mg fecal matrix sample+990 μL acetonitrile+10 μL L1, vortexed to mix uniformly;

the concentrations of the standards added were as follows: acetic acid of 107.4069 μM, propionic acid of 80.3186 μM, isobutyric acid of 63.1065 μM, butyric acid of 64.9225 μM, isovaleric acid of 53.5581 μM, valeric acid of 54.3414 μM and caproic acid of 45.8858 μM.

Six treatments were performed in parallel for each solvent. The samples were placed symmetrically in a high-speed centrifuge for centrifugation at 4 °C, 12000 g for 10 min.

### (2) Purification of Spiked Matrix Sample:

The C8+SAX solid phase extraction column was activated with 1 mL acetone, methanol and acetonitrile, respectively (wherein the mass ratio of C8:SAX=1:1, with C8 at the top and SAX at the bottom), and the residual acetone was removed by blowing dry. A clean 10 mL centrifuge tube was placed under the solid phase extraction column. The supernatant extract of the spiked matrix sample was added into the purification column. The impurities were adsorbed into the packing material of the solid phase extraction column, and the sample flowing out was short-chain fatty acid.

### (3) Detection of Spiked Matrix Sample:

Chromatographic analysis was performed by Agilent 7820A gas chromatography and Agilent DB-FFAP gas chromatographic columns. The condition for the gas phase analysis was as follows: the injector port heater was 280 °C with the pressure of 11.258 psi and split ratio of 10:1; the chromatographic column was Agilent DB-FFAP (30 m, 0.25 mm×0.25 μm), using N₂ as the carrier gas. The flow rate was 1 mL/min, and the pressure was 11.258 psi. The column oven was kept at 50 °C for 1 min, and was warmed at 15 °C/min to 120 °C which was kept for 0 min. Then it was warmed at 6 °C/min to 200 °C which was kept for 0 min. It ran for 19 min in total. Then it post-ran at 235 °C for 3 min; the FID detector was warmed at 250 °C, with the H₂ flow rate of 40 mL/min, the air flow rate of 300 mL/min, and the make-up gas flow rate (N₂) of 25 mL/min; the injection volume of GC autosampler was 1 μL, using water as wash solvent A and acetone as wash solvent B. Before injection, it was washed twice by A and B with the maximum volume, respectively. The sample was cleaned with 4 μL twice and sucked for 3 times.

### (4) Calculation Formula for the Recovery:

Recovery=(spiked matrix concentration−matrix concentration)/(added standard concentration)×100%. The results are shown in Table 7.

TABLE 7

| | Acetone | Methanol | Acetonitrile |
|---|---|---|---|
| | extract | extract | extract |
| Acetic acid | 83.42 ± 1.35 | 70.15 ± 1.60 | 70.83 ± 1.91 |
| Propionic acid | 91.96 ± 1.16 | 72.65 ± 1.68 | 78.54 ± 1.31 |
| Isobutyric acid | 93.19 ± 1.39 | 66.11 ± 1.12 | 75.55 ± 1.27 |
| Butyric acid | 91.72 ± 1.96 | 72.93 ± 1.15 | 77.45 ± 1.49 |
| Isovaleric acid | 94.62 ± 1.37 | 79.07 ± 1.58 | 74.41 ± 1.85 |
| Valeric acid | 93.84 ± 1.78 | 81.01 ± 2.76 | 81.00 ± 1.67 |
| Caproic acid | 97.79 ± 1.41 | 84.09 ± 1.31 | 84.42 ± 1.56 |

Results in Table 7 show that the spiked recoveries of short-chain fatty acids extracted from treated pig feces by acetone solvent are 83.42%-97.79%, the spiked recoveries of short-chain fatty acids extracted by methanol solvent are 66.11%-84.09%, and the spiked recoveries of short-chain fatty acids extracted by acetonitrile solvent are 70.83%-84.42%, indicating that the recovery extracted by acetone is better.

### Comparative Example 2

In the present comparative example, short-chain fatty acids were extracted from the pig fecal matrix sample spiked with mixed standard using acetone, which were purified by C8+SAX, SAX, and CN cyano-based materials, respectively.

It includes the following steps:

(1) Dissolution of Matrix Sample Spiked with Standard:

Acetone extract: 50 mg fecal matrix sample+990 μL acetone+10 μL L1, vortexed to mix uniformly;
the concentrations of the standards added were as follows: acetic acid of 107.4069 μM, propionic acid of 80.3186 μM, isobutyric acid of 63.1065 μM, n-butyric acid of 64.9225 μM, isovaleric acid of 53.5581 μM, n-valeric acid of 54.3414 μM and caproic acid of 45.8858 μM.

Six treatments were performed in parallel for each purified material. The samples were placed symmetrically in a high-speed centrifuge for centrifugation at 4 °C, 12000 g for 10 min.

### (2) Purification of Spiked Matrix Sample:

1 mL acetone was used to activate the solid phase extraction column of C8+SAX (wherein the mass ratio of C8:SAX=1:1, with C8 at the top and SAX at the bottom), SAX and CN cyano-based materials, respectively, and the residual acetone was removed by blowing dry; a clean 10 mL centrifuge tube was placed under the solid phase extraction column. The supernatant extract of the spiked matrix sample was added into the purification column. The impurities were adsorbed into the packing material of the solid phase extraction column, and the sample flowing out was short-chain fatty acid.

### (3) Detection of Spiked Matrix Sample:

Chromatographic analysis was performed by Agilent 7820A gas chromatography and Agilent DB-FFAP gas chromatographic columns. The condition for the gas phase analysis was as follows: the injector port heater was 280 °C with the pressure of 11.258 psi and split ratio of 10:1; the chromatographic column was Agilent DB-FFAP (30 m, 0.25 mm×0.25 μm), using N₂ as the carrier gas. The flow rate was 1 mL/min, and the pressure was 11.258 psi. The column oven was kept at 50 °C for 1 min, and was warmed at 15 °C/min to 120 °C which was kept for 0 min. Then it was warmed at 6 °C/min to 200 °C which was kept for 0 min. It ran for 19 min in total. Then it post-ran at 235 °C for 3 min; the FID detector was warmed at 250 °C, with the H₂ flow rate of 40 mL/min, the air flow rate of 300 mL/min, and the make-up gas flow rate (N₂) of 25 mL/min; the injection volume of GC autosampler was 1 μL, using water as wash solvent A and acetone as wash solvent B. Before injection, it was washed twice by A and B with the maximum volume, respectively. The sample was cleaned with 4 μL twice and sucked for 3 times.

### (4) Calculation Formula for the Recovery:

Recovery=(spiked matrix concentration−matrix concentration)/(added standard concentration)×100%. The results are shown in Table 8.

TABLE 8

| | C8 + SAX | SAX | CN cyano-based |
|---|---|---|---|
| Acetic acid | 84.62 ± 1.87 | 72.48 ± 1.61 | 72.75 ± 1.25 |
| Propionic acid | 91.22 ± 1.28 | 78.78 ± 2.05 | 75.78 ± 2.04 |
| Isobutyric acid | 95.10 ± 1.16 | 87.84 ± 1.95 | 79.29 ± 1.31 |
| Butyric acid | 91.14 ± 1.24 | 80.14 ± 2.03 | 77.21 ± 1.52 |
| Isovaleric acid | 93.64 ± 1.29 | 83.87 ± 1.60 | 78.05 ± 1.81 |
| Valeric acid | 95.70 ± 1.42 | 82.25 ± 1.26 | 76.82 ± 1.45 |
| Caproic acid | 95.73 ± 1.27 | 86.67 ± 1.11 | 77.65 ± 1.67 |

Results in Table 8 show that the spiked recoveries of short-chain fatty acids extracted from treated pig feces by C8+SAX material are 84.62%-95.73%, the spiked recoveries of short-chain fatty acids extracted by SAX material are 72.48%-87.84%, and the spiked recoveries of short-chain fatty acids extracted by CN cyano-based material are 72.75%-79.29%, indicating that the recovery extracted by method using C8+SAX material is better.

It should be noted that neither the endpoints nor any of the values of the ranges disclosed herein are limited to the exact range or value. Such range or value should be understood as containing values close to such range or value. For a numeric range, one or more new numeric ranges can be combined between the endpoint values of the range, between the endpoint value of the range and individual point value, and between individual point values, which shall be deemed to be specifically disclosed herein.

In the description of the present specification, the description of reference terms “an embodiment”, “some embodiments”, “a specific embodiment”, or “some specific embodiments”, etc., intends to refer to that the specific features, structures, materials, or characteristics described in conjunction with the embodiment or example are included in at least one embodiment or example in the present disclosure. In the present specification, the exemplary expression of the aforesaid terms need not be directed to the identical embodiment or example. Moreover, the specific features, structures, materials or characteristics described may be combined in a suitable way in any one or more embodiments or examples. In addition, in case of no conflict, those skilled in the art may combine and compose the different embodiments or examples and the characteristics thereof described herein.

Finally, it should be noted that the aforesaid examples are only used to illustrate the technical solution of the present disclosure but not to limit it; while the present disclosure has described in detailed description in conjunction with the aforesaid embodiments, those of ordinary skill in the art should understand that it is still possible to make modification to the technical solution provided in the each aforesaid embodiment, or make equivalent substitution to some of the technical features thereof; such modification or substitution shall not make the essence of the corresponding technical solution depart from the spirit and scope of the technical solution of each example in the present disclosure.

What is claimed is:

1. A method for determining the content of short-chain fatty acids in intestinal contents or feces, characterized in that it comprises a step of sample pre-treatment, wherein acetone is firstly used as an extraction solvent to extract short-chain fatty acids in a sample of intestinal contents or feces, and the acetone extract of short-chain fatty acids obtained by the extraction is separated and purified by a solid phase extraction column, wherein C8 and SAX are used as the packing material of the solid phase extraction column, and the mass ratio between C8 and SAX is 1:3~3:1, and the packing material is filled in sections with the C8 packing material at the top and the SAX packing material at the bottom;
the procedure for the extraction is as follows: adding 50 mg-150 mg of the sample of intestinal contents or feces into a centrifuge tube, adding 300 μL-400 μL acetone for grinding, and adding additional 600 μL-700 μL acetone and making the sample uniform by vortex, and high-speed centrifuging the sample at 4 °C, 10000 g-12000 g for 10 min-15 min after the vortex;
the procedure for the separation and purification is as follows: firstly activating the solid phase extraction column with acetone, removing the residual acetone by blowing dry, and adding the acetone extract of short-chain fatty acids into the solid phase extraction column, wherein the eluate is a sample solution of the short-chain fatty acids;
the method further comprises: determining the content of short-chain fatty acids by conducting gas chromatography on the sample solution obtained from the sample pre-treatment, and the chromatographic column used in the gas chromatography is Agilent DB-FFAP and the detector is FID;
the short-chain fatty acids are acetic acid, propionic acid, isobutyric acid, n-butyric acid, isovaleric acid, n-valeric acid and caproic acid.

2. The method for determining the content of short-chain fatty acids in intestinal contents or feces according to claim 1, characterized in that the gas chromatography is conducted in temperature programming, wherein the temperature programming is as follows: keeping the initial temperature of the column at 50 °C for 1 min, warming at 15 °C/min to 120 °C which is kept for 0 min, and warming at 6 °C/min to 200 °C which is kept for 0 min, totally running for 19 min; and then warming to 235 °C to post-run for 3 min.

3. The method for determining the content of short-chain fatty acids in intestinal contents or feces according to claim 1, characterized in that the detection condition for the gas chromatography is as follows: using Agilent DB-FFAP (30 m, 0.25 mm×0.25 μm) as the chromatographic column and N₂ as the carrier gas, flow rate of 1 mL/min, pressure of 11.258 psi, injector port temperature of 280 °C, FID detector temperature of 250 °C, H₂ flow rate of 40 mL/min, air flow rate of 300 mL/min, N₂ make-up gas flow rate of 25 mL/min; sample size of 1 μL, and using water as wash solvent A and acetone as wash solvent B.

4. The method for determining the content of short-chain fatty acids in intestinal contents or feces according to claim 2, characterized in that the detection condition for the gas chromatography is as follows: using Agilent DB-FFAP (30 m, 0.25 mm×0.25 μm) as the chromatographic column and N₂ as the carrier gas, flow rate of 1 mL/min, pressure of 11.258 psi, injector port temperature of 280 °C, FID detector temperature of 250 °C, H₂ flow rate of 40 mL/min, air flow rate of 300 mL/min, N₂ make-up gas flow rate of 25 mL/min; sample size of 1 μL, and using water as wash solvent A and acetone as wash solvent B.
